(19) United States
(12) Patent Application Publication
(10) Pub. No.: US 2015/0246802 A1
(43) Pub. Date: Sep. 3, 2015

(54) JAR OPENING DEVICE

(71) Applicant: Shay Heitz, Venice, FL (US)

(72) Inventor: Shay Heitz, Venice, FL (US)

(21) Appl. No.: 14/195,028

(22) Filed: Mar. 3, 2014

(51) Int. Cl. B67B 7/18

(52) U.S. Cl. CPC B67B 7/18

(57) ABSTRACT

A container opening device comprising a housing, where the housing is anchored to a stationary object; at least one concentric grabber within the housing, where the concentric grabber receives a lid of a container; a series of grips within the concentric grabber, where the series of grips are arranged stepwise with gradually smaller diameters within the concentric grabber; and an actuator switch attached to the housing, where the actuator switch initiates the grips to close around the container lid, and where the actuator switch opens the grips after the lid is removed.

### BACKGROUND OF THE INVENTION

1. Field of the Invention

The present invention relates to a device to assist a user to unscrew a jar lid.

2. Description of Related Art

Most jars and bottles include a threaded lid which tightly and securely keeps the lid in place during storage. The lids prevent spills, and keep out air, water, and debris to ensure that the containers stay fresh and free of bacteria. Because these lids are so efficient, many people have difficulty removing them especially for the initial opening. Other times the contents of the jar may leak between the lid and the neck practically creating a glue that fastens the lid in place. If the lid does not twist a variety of methods have been developed to open the jars. First, simply asking another person to perform the task. Second, tapping the edge of the lid against a counter to loosen. This is dangerous because the jar or bottle may crack or shatter upon impact. Third, running the lid under hot water. But the water may heat the lid too much or cause the container to be slippery therefore compromising grip. If all these methods fail then the user typically declares defeat and puts the jar aside.

Bottle and jar opening is especially difficult for people with arthritis, weak muscles and joints, disabilities and those who have recently undergone surgery. Their grip is not ideal therefore making the task impossible. A few tools have been developed to assist in opening. First, a rubber grip pad is used to envelop the lid thereby creating extra friction between the lid and the hand for removal. Alternatively, a twisting lever jar opener is employed to remove the lid. The jar opener includes an elongated frame with two or more divisions which receive the lid. During use the person grasps the handle and turns the opener like a lever to pry open the jar. While these devices are helpful, they are still difficult to use for those who cannot close their hand small enough to fit over the lid or tightly grasp the handle.

Therefore it would be beneficial in the art to provide a jar opening tool that tightly fastens around the lid for opening. It would also be desirable in the art to provide a jar opening tool that accommodates jars of varying sizes.

### SUMMARY OF THE INVENTION

In view of the foregoing disadvantages inherent in the prior art, the general purpose of the present invention is to provide a container opening device to assist users to open jars, configured to include all of the advantages of the prior art, and to overcome the drawbacks inherent therein.

Accordingly, an object of the present invention is to provide a container opening device that tightly fastens onto the lid of a container to lock the lid in place while the user twist the jar.

Another object of the present invention is to provide a container opening device with multiple receiving portions so that containers of varying sizes can be opened with the single tool.

To achieve the above objects, in an aspect of the present invention, a container opening device is described comprising a housing, where the housing is anchored to a stationary object; at least one concentric grabber within the housing, where the concentric grabber receives a lid of a container; a series of grips within the concentric grabber, where the series of grips are arranged stepwise with gradually smaller diameters within the concentric grabber; and an actuator switch attached to the housing, where the actuator switch initiates the grips to close around the container lid, and where the actuator switch opens the grips after the lid is removed.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a container opening device in accordance with an exemplary embodiment of the present invention; and

FIG. 2 depicts a side view of a concentric grabber within a container opening device in accordance with an exemplary embodiment of the present invention.

Like reference numerals refer to like parts throughout the description of several views of the drawings.

### DETAILED DESCRIPTION OF THE DRAWINGS

The present invention relates to a device to assist a user to unscrew a jar lid. The present invention provides a jar opening device to facilitate removing the tops and caps of jars, bottles, and containers with minimal effort. The jar opening device includes a housing with three concentric grabbers. The grabbers envelop the top of the jar until a tight immobile seal is created. Next the user simply twists the jar itself to remove the lid. This way the user is not struggling with the lid to twist but rather twisting the jar while the lid remains stationary. The jar opening device allows those who do not have full use of their hands and fingers a way to effortlessly opening jars.

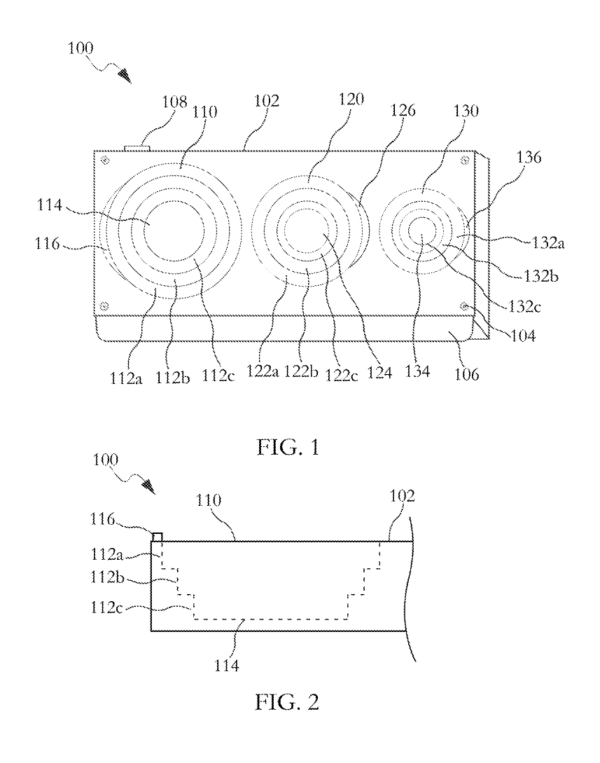

Turning now descriptively to the drawings, referring to FIG. 1, a container opening device 100 is shown in accordance with an exemplary embodiment of the present invention. The container opening device 100 includes a housing 102 with a generally cuboidal shape. The housing 102 may be attached to a counter, wall or even below the overhang of a cabinet with a set of screws 104. By attaching the housing 102 to a stationary object the container opening device 100 is provided an anchor to ensure that it does not move during use. At an edge of the housing 102 may be a drip try 106 which collects any juices or food items that fall from a container after opening.

Aligned on a top surface of the housing 102 is a plurality of concentric grabbers 110, 120, 130. The concentric grabbers 110, 120, 130 attach to a top or lid of the container. The concentric grabbers 110, 120, 130 are arranged according to diameter size, where a first concentric grabber 110 with the largest diameter is at an end followed by a second concentric grabber 120 with a smaller diameter and finally a third concentric grabber 130 with the smallest diameter. Within each concentric grabber 110, 120, 130 may be a center portion 114, 124, 134 which is positioned close to the lid to braces it for opening.

Within the first concentric grabber 110 are a series of grips 112a, 112b, 112c that are arranged like concentric circles positioned from an edge of the grabber 110 to the center portion 114. The series of grips 112a, 112b, 12c may include 2-5 grips. The first concentric grabber 110 may receive large containers like pickle jars, sauce jars, mayo tubs and the like. The second concentric grabber 120 also includes a series of grips 122a, 122b, 122c that ends at the center portion 124. The second grabber 120 may open containers like juice bottles, salsa jars, or jelly jars. Finally the third concentric grabber 130 includes a series of grips 132a, 132b, 132c before reaching the center portion 134. The third grabber 130 may open containers like hot sauce or steak sauce bottles, drinking bottles and the like containers with small diameter lids. The grips may be rubber to ensure an airtight yet gentile grasp on the lid.

An actuator switch 108 is positioned on the housing 102. When the actuator switch 108 is turned on the grips 112, 122, 132 within the concentric grabbers 110, 120, 130 close around the lid of the container until tightly withheld within the grabber 110, 120, 130. After the grips 112, 122, 132 are closed around the lid a lock 116, 126, 136 is pressed to prevent the container from moving. Once secure, the user may twist the container to loosen or remove the lid. To release the lid the user simply presses the lock 116, 126, 136 a second time to unlock the grips 112, 122, 132 and then presses the actuator switch 108 to open the grabbers 110, 120, 130.

Referring now to FIG. 2, a side view of the first concentric grabber 110 is shown. FIG. 2 illustrates the first concentric grabber 110 but the design is also applicable to second grabber 120 and the third grabber 130. The grips 112a, 112b, 112c are arranged stepwise into the housing 102, shrinking in diameter until they reach the center portion 114. This way the container opening device 100 may accommodate bottles and jars of varying sizes and shapes. With the container opening device 100 the user is able to open a wide variety of containers without the difficulty and strain commonly associated with jar opening.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A container opening device comprising:
a. a housing, where the housing is anchored to a stationary object;
b. at least one concentric grabber within the housing, where the concentric grabber receives a lid of a container;
c. a series of grips within the concentric grabber, where the series of grips are arranged stepwise with gradually smaller diameters within the concentric grabber; and
d. an actuator switch attached to the housing, where the actuator switch initiates the grips to close around the container lid, and where the actuator switch opens the grips after the lid is removed.

2. The container opening device according to claim 1, where the housing includes a first concentric grabber, a second concentric grabber and a third concentric grabber, where the first, second, and third grabbers are arranged from widest to smallest diameter.

3. The container opening device according to claim 1, where the concentric grabber includes a central portion, where the central portion rests within the concentric grabber, closest to the lid of the container.

4. The container opening device according to claim 1, where the concentric grabber includes a lock, where the lock secures the lid within the series of grips.

5. The container opening device according to claim 1, where the housing includes a set of screws to fasten the housing to the stationary object.

6. The container opening device according to claim 1, where the stationary object is one of at least a counter, a wall or a cabinet.

7. The container opening device according to claim 1, where the housing includes a drip tray.

8. The container opening device according to claim 1, where the series of grips are rubber.
